(19) United States
(12) Patent Application Publication
(10) Pub. No.: US 2005/0087615 A1
(43) Pub. Date: Apr. 28, 2005

(54) Thermal shielding assembly for sensors

(76) Inventor: Benjamin Valles, Juarez (MX)

Correspondence Address: DELPHI TECHNOLOGIES, INC., M/C 480-410-202, PO BOX 5052, TROY, MI, 48007, US

(21) Appl. No.: 10/695,305

(22) Filed: Oct. 28, 2003

(51) Int. Cl. G05D 23/00

(52) U.S. Cl. 236/91 C; 236/91 F

(57) ABSTRACT

A sensing assembly protects a sensor and an electronic connector therefor from excess thermal energy. The sensing assembly includes a connector cover for housing the electronic connector. The connector cover includes a connector opening for accessing the electrical connector and a sensor opening for providing the sensor access to the electronic connector. The sensing assembly also includes a ceramic shield that covers the sensor extending out of the sensor opening. The ceramic shield protects the sensor and the electronic connector from excess thermal energy.

### BACKGROUND ART

1. Field of the Invention

The invention relates to a thermal shielding assembly. More particularly, the invention relates to a thermal shielding assembly for a sensor placed in a high temperature environment.

2. Description of the Related Art

Many mechanisms utilize multiple sensors to measure parameters thereof. These sensors may also measure parameters of the ambient conditions of the mechanism. The increased number of sensors is directly related to the increased technology in the manufacture of the sensors as well as the enhanced computing capability of control circuits that function to control the operations of the mechanisms that host the sensors.

In the instance of a motor vehicle, many sensors are used to enhance the quality of the operation of the motor vehicle. The sensors are available in analog and digital format. The sensors translate the mechanical motions into electrical signals that are received and interpreted by a control circuit, e.g., an engine control unit, so that the control circuit may adjust certain parameters to maximize or optimize the output of the motor vehicle.

In many instances, the mechanical motion of a ferromagnetic target wheel converts the rotational movement thereof into an electrical signal to identify speed and angular position of a particular component of the motor vehicle.

One such component of the motor vehicle is the wheel and/or tire. Placing a sensor near the wheel provides excellent data to be utilized by the engine control unit. A major problem with placing a sensor at a location to measure the rotation of the wheel is that the environment is extremely hostile. More specifically, a sensor will experience a great deal of vibration. In addition, the sensor placed near the wheel will experience extreme temperature shifts. The increase in temperature is due to the friction between the tire and the road on which the motor vehicle is traveling. Friction is also generated by the application of a brake to stop the motor vehicle. In the instance when the brake is being applied, the temperature in the wheel becomes extremely high in a very short period of time. Therefore, thermal protection must be provided to prevent the sensor from failing prematurely.

### SUMMARY OF THE INVENTION

A sensing assembly protects a sensor and an electronic connector therefor from excess thermal energy. The sensing assembly includes a connector cover for housing the electronic connector. The connector cover includes a connector opening for accessing the electrical connector and a sensor opening for providing the sensor access to the electronic connector. The thermal shielding assembly also includes a ceramic shield that covers the sensor extending out of the sensor opening. The ceramic shield protects the sensor and the electronic connector from excess thermal energy.

### BRIEF DESCRIPTION OF THE DRAWINGS

Advantages of the invention will be readily appreciated as the same becomes better understood by reference to the following detailed description when considered in connection with the accompanying drawings, wherein:

FIG. 1 is a perspective view of a wheel of a motor vehicle including one embodiment of the invention; and

FIG. 2 is a side view of the invention.

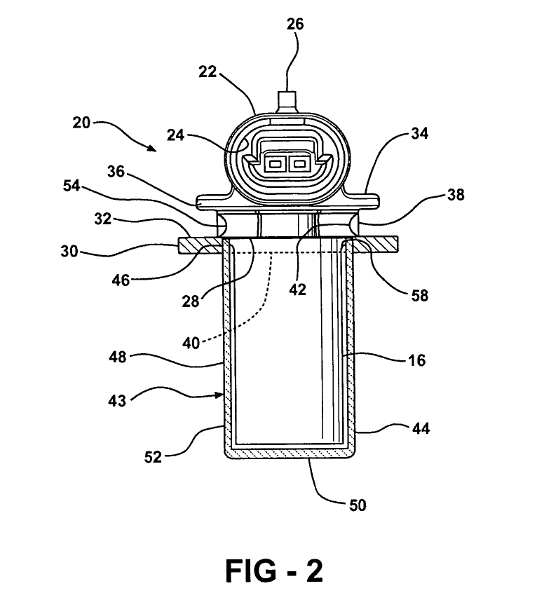

### DETAILED DESCRIPTION OF THE PREFERRED EMBODIMENT

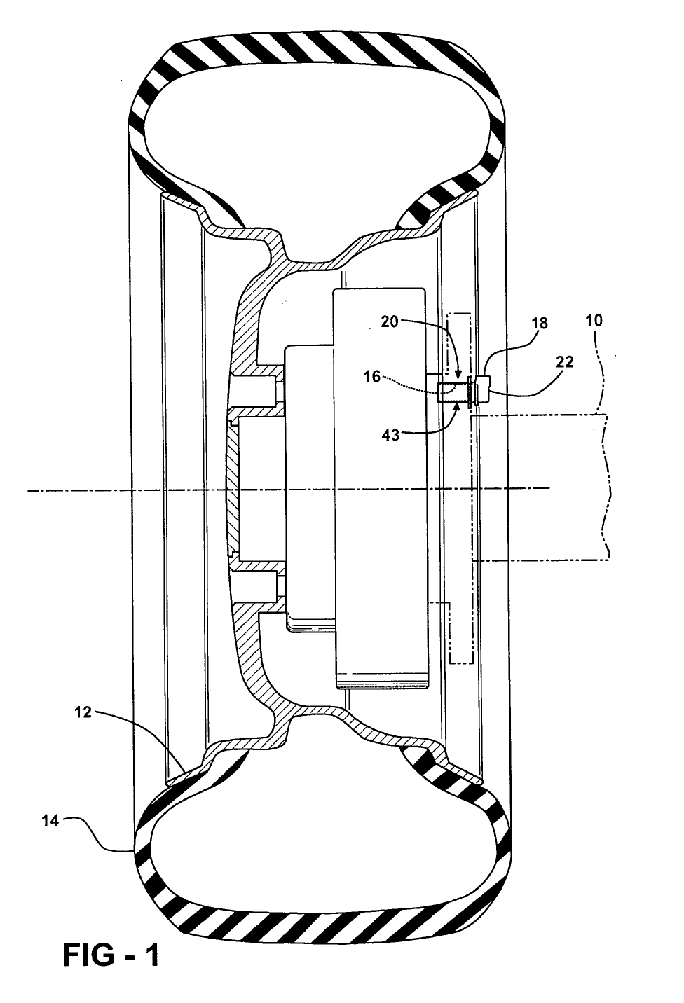

Referring to FIG. 1, a motor vehicle 10 is shown partially cut away. The motor vehicle includes a wheel 12 having a tire 14 mounted thereto. It should be appreciated by those skilled in the art that a motor vehicle 10 may have any number of wheels 12 and tires 14 and only one is shown in the Figures for clarity purposes. The wheel 12 is rotated when a force generated by the internal combustion engine of the motor vehicle 10 is transferred to one or more of the wheels 12. The motor vehicle 10 is stopped by activating the brakes disposed adjacent each of the wheels 12. It is the activation of the brakes that creates the extreme spikes of temperature at locations surrounding the wheel 12.

A sensing assembly is generally indicated at 20. The sensing assembly 20 is designed to place a sensor 16 adjacent the wheel 12. The sensor 16 is capable of generating a sensing signal that is used by an engine control unit (not shown) to calculate the speed and angular displacement of the wheel 12. The sensor 16 is connected to the engine control unit through an electronic connector 18. The sensor 16 and electronic connector 18 may be well known in the art. Portions of the sensing assembly 20 are designed to protect the sensor 16 and the electrical connector 18 from excess thermal energy generated by the operation of the wheel 12.

When a temperature gradient exists in a body, experience has shown that there is an energy transfer from the high-temperature region to the low temperature region. The energy is transferred by conduction and the heat-transfer rate per unit area is proportional to the normal temperature gradient, as is indicated by the following formula:
q/A≈δT/δx

When the proportionality constant is inserted,
q=−kAδT/δx=−kA(T2−T1)/X
where q is the heat transfer rate and δT/δx is the temperature gradient in the direction of the heat flow. The positive constant k is called the thermal conductivity of the material, and the minus sign is inserted so the second principle of thermodynamic will be satisfied.

Then, using two materials, Nylon 6/6, 33% glass filled, and Ceramic Aluminate, a comparison of the temperature drop of Nylon polymer 66, 33% glass filled, versus a ceramic aluminate is made with identical thickness, the thermal conductivity comparison is as follows:
Nylon 6/6 33 GF: k=0.25 w/m ° C.; and
Ceramic Aluminite: k=70.79 w/m ° C.

Therefore, the plastic offers less resistant to transmit the heat compared with the ceramic material, so the insulation sleeve will reduce the inside temperature of the embodiment.

The sensing assembly 20 includes a connector cover 22. The connector cover 22 houses the electrical connector 18. The connector cover 22 includes a connector opening 24 that provides access for the electrical connector 18. The connector opening 24 is adapted to receive a plug-style electrical connection to positively connect the electronic connector 18 to the engine control unit. The connector cover 22 includes a tab 26 extending out from the connector cover 22 that is received by an aperture or a snap in the plug-style connector to lock the plug-style connector to the electronic connector 18.

The connector cover 22 also includes the sensor opening 28 that provides the sensor 16 access to the electronic connector 18. In the embodiment shown in the Figures, the sensor opening 28 and the connector opening 24 are generally perpendicular to each other. It should be appreciated by those skilled in the art that the orientation of the sensor opening 28 with respect to the connector opening 24 may vary without deviating from the scope of the invention.

The connector cover 22 also includes a connection ring 30 that extends around the connector cover 22. The connector ring 30 provides a connection abutment surface 32 that faces the majority of the connector cover 22. The connector cover 22 also includes a fastener ring 34 that extends around the connector cover 22. The fastener ring 34 provides a fastener abutment surface 36 that faces and complements the connection abutment surface 32. More specifically, a fastener designed to hold the sensing assembly 20 in place with respect to the wheel 12 (not shown) would be held in place between the connection 32 and fastener 36 abutment surfaces. The sensing assembly 20 is held in place by preventing the connector cover 22 from moving with respect to the fastener by mounting the fastener between the connection abutment surface 32 and the fastener abutment surface 36. Together, the fastener ring 34 and the connection ring 30 form a fastener channel 38 that receives the fastener therein.

The connector cover 22 defines a sensor opening 28. The sensor opening 28 is disposed adjacent a port to which the sensor 16 is connected to the electronic connector 18. The sensor opening 28 defines a flange 42 that extends inwardly toward the center of the sensor opening 28. The flange 42 will be discussed in greater detail subsequently.

The sensing assembly 20 also includes a thermal shielding assembly, generally shown at 43. The thermal shielding assembly 43 includes ceramic shield 44 that is received by the sensor opening 28 and secured to the connector cover 22. The ceramic shield 44 extends around the entire sensor 16 and is designed to prevent the sensor 16 from absorbing thermal energy generated by the wheel 12. The ceramic shield 44 includes a shield port 46 that receives the sensor 16 therethrough. The shield port 46 is an opening that communicates with the sensor opening 28. The ceramic shield 44 also includes an outer wall 48. In the embodiment shown, the ceramic shield 44 includes a single outer wall. It should be appreciated by those skilled in the art that there may be a plurality of outer walls 48, depending on the design parameters of the sensor 16 being protected.

A distal cover 50 extends over a distal end 52 of the outer wall 48. The distal cover 50 prevents thermal energy from going around the outer wall 48. Therefore, this ceramic shield 44 creates a closed environment to which there is no access to the sensor 16 without going through the ceramic shield 44.

The thermal shielding assembly 43 includes a fastener groove 54 that extends along the outer wall 48. More specifically, the fastener groove 54 extends along the outer wall 48 at a location disposed adjacent the shield port 46. The fastener groove 54 receives the flange 42 of the connector cover 22 therein. The flange 42 and fastener groove 54 work together to secure thermal shielding assembly 43 to the connector cover 22.

The ceramic shield 44 includes a seal groove 56 that extends along the outer wall 48 disposed adjacent the fastener grove 54. The fastener groove 54 and the seal groove 56 are two grooves that extend peripherally around the outer wall 48. In addition, the grooves 54, 56 are parallel to each other. The seal groove 56 receives an O-ring 58 that is fabricated from a suitable thermal set resin capable of withstanding the environment in which the thermal shielding assembly 43 is being placed while maintaining its pliability to prevent contaminants from entering the ceramic shield 44 and damaging the sensor 16.

The invention has been described in an illustrative manner. It is to be understood that the terminology, which has been used, is intended to be in the nature of words of description rather than of limitation.

Many modifications and variations of the invention are possible in light of the above teachings. Therefore, within the scope of the appended claims, the invention may be practiced other than as specifically described.

1. A sensing assembly for protecting a sensor and an electronic connector therefore from excess thermal energy, said sensing assembly comprising:
a connector cover for housing the electronic connector, said connector cover including a connector opening for accessing the electronic connector and a sensor opening for providing the sensor access to the electronic connector; and
a ceramic shield covering the sensor extending out of said sensor opening to shield the sensor and the electronic connector from the excess thermal energy.

2. A sensing assembly as set forth in claim 1 wherein said ceramic shield includes a shield port for receiving the sensor therethrough.

3. A sensing assembly as set forth in claim 2 wherein said ceramic shield includes an outer wall.

4. A sensing assembly as set forth in claim 3 wherein said ceramic shield includes a fastener groove extending along said outer wall disposed adjacent said shield port.

5. A sensing assembly as set forth in claim 4 wherein said connector cover includes a flange for engaging said fastener groove to fasten said ceramic shield to said connector cover.

6. A sensing assembly as set forth in claim 4 wherein said ceramic shield includes a seal groove extending along said outer wall disposed adjacent said fastener groove.

7. A sensing assembly as set forth in claim 6 including an O-ring positioned within said seal groove about said outer wall to provide a seal between said ceramic shield and said connector cover.

8. A sensing assembly as set forth in wherein said connector cover includes a connection ring providing a connection abutment surface facing said connector cover.

9. A sensing assembly as set forth in claim 8 including a fastener ring providing a fastener abutment surface facing and complementing said connection abutment surface said fastener ring and said connection ring forming a fastener channel to receive a fastener thereagainst to secure said thermal shielding assembly and the sensor in a predetermined location.

10. A thermal shielding assembly for protecting a sensor from excess thermal energy, the electronic connector and an electronic connector covered by a connector cover having a sensor opening, said thermal shielding assembly comprising:
a ceramic shield covering the sensor extending out of the sensor opening to shield the sensor and the electronic connector from the excess thermal energy;
a seal groove extending about said ceramic shield; and
an O-ring positioned within said seal groove to provide a seal between said ceramic shield and the connector cover.

11. A thermal shielding assembly as set forth in claim 10 wherein said ceramic shield includes a shield port for receiving the sensor therethrough.

12. A thermal shielding assembly as set forth in claim 11 wherein said ceramic shield includes an outer wall.

13. A thermal shielding assembly as set forth in claim 12 wherein said ceramic shield includes a fastener groove extending along said outer wall disposed adjacent said shield port.
